(19) United States
(12) Patent Application Publication
(10) Pub. No.: US 2016/0069778 A1
(43) Pub. Date: Mar. 10, 2016

(54) SYSTEM AND METHOD FOR PREDICTING ASSOCIATED FAILURE OF MACHINE COMPONENTS

(71) Applicant: CATERPILLAR INC., Peoria, IL (US)

(72) Inventor: Subrat SAHU, Peoria, IL (US)

(73) Assignee: CATERPILLAR INC., Peoria, IL (US)

(21) Appl. No.: 14/482,631

(22) Filed: Sep. 10, 2014

(51) Int. Cl. G01M 17/00

(52) U.S. Cl. CPC G01M 17/00

(57) ABSTRACT

A system for predicting failure of one or more components of a machine is disclosed. The system includes at least one interface configured for inputting current repair data for a first component, a database configured to log the current repair data of the first component, and a processor operably connected to the at least one interface and the database. The processor analyzes the current repair data of the first component based on historic repair data stored in the database, wherein the historic repair data includes the identity of a plurality of components of the machine, including the first component and a second component. The processor generates a recommendation for servicing the second component based on the historic repair data stored in the database.

### TECHNICAL FIELD

The present disclosure is directed to the field of parts repair and replacement and, more particularly, to a system and method for predicting associated failure of machine components.

### BACKGROUND

The diagnosis, maintenance, and repair of complex products, such as vehicles, appliances, industrial equipment, and other complex products can be difficult and time consuming. Expert knowledge and/or expensive diagnostic equipment may be required to ensure that the products can be properly diagnosed, maintained, or repaired. People involved in the repair and maintenance of such complex machines understand that when a complex machine is taken out of service for repair or maintenance, unanticipated defects may be discovered.

Various tools have been developed to assist with such tasks. One such tool is described in U.S. Patent Application Publication No. 2005/0144183 to McQuown et al. (the '183 publication). The '183 publication describes a handheld portable unit that can be used by a locomotive technician on-site to access information needed to repair, diagnose, and troubleshoot locomotive problems and undertake necessary repairs. For example, the technician can download schematics, repair manuals, repair recommendations, and other resources to help complete the task at hand. In addition, the technician can use the portable unit to order needed parts from a supplier.

Although the portable unit of the '183 publication may help a technician diagnose, maintain, and repair a locomotive, it may be inadequate. The on-site technician may identify a particular part of the locomotive that needs to be replaced and, thus, order the part using the portable unit. However, the portable unit may not identify other related parts that should be ordered along with the part to ensure the technician can complete any associated repair to preempt any associated failure that could occur unanticipated within a specified time window in near future. The technician is thus required to have the knowledge and foresight to identify such related parts at the time of the order. Due to the complexity of machines and the difficulty in being able to identify related parts, defects may be ignored or go unnoticed. The unit of the '183 publication also does not provide an indication of possible associated repairs to different components, sub-systems, or systems that should be addressed during an inspection. The on-site technician may thus need to have several years of experience and be able to correlate the occurrence of various related or seemingly-unrelated premature failures, which can be difficult or impossible for certain complex machines. This may lead to an operating condition where a breakdown is imminent.

Complex machines, including but not limited to off-highway mining trucks, hydraulic excavators, track-type tractors, and wheel loaders, may represent large capital investments and be capable of substantial productivity when operating. It may therefore be important to predict component, sub-system, and/or system failures so that servicing can be scheduled during periods in which productivity will be less affected, and so that any minor repairs can be made before they lead to potentially catastrophic failures.

The present disclosure is directed to overcoming one or more of the problems set forth above and/or other shortcomings in existing technologies.

### SUMMARY

One aspect of the disclosure is directed to a system for predicting failure of one or more components of a machine is disclosed. The system may include at least one interface configured for inputting current repair data for a first component, a database configured to log the current repair data of the first component, and a processor operably connected to the at least one interface and the database. The processor may analyze the current repair data of the first component based on historic repair data stored in the database, wherein the historic repair data includes the identity of a plurality of components of the machine, including the first component and a second component. The processor may generate a recommendation for servicing the second component based on the historic repair data stored in the database.

Another aspect of the disclosure is directed to a method of predicting failure of components of a machine. The method may include inputting current repair data for a first component of the machine into a database, and processing the repair data. The processing may include analyzing the current repair data of the first component based on historic repair data stored in the database, wherein the historic repair data includes the identity of a plurality of components of the machine, including the first component and a second component. The processing may also include generating a recommendation for servicing the second component based on the historic repair data stored in the database, and outputting a recommended repair checklist.

Yet another aspect of the disclosure is directed to a computer-readable medium having stored thereon computer-readable instructions which, when executed by a processor, cause the processor to perform a method of predicting failure of one or more components of a machine. The method may include inputting current repair data for a first component of the machine into a database, and processing the repair data. The processing may include analyzing the current repair data of the first component based on historic repair data stored in the database, wherein the historic repair data includes the identity of a plurality of components of the machine, including the first component and a second component. The processing may also include generating a recommendation for servicing the second component based on the historic repair data stored in the database, and outputting a recommended repair checklist.

### BRIEF DESCRIPTION OF THE DRAWINGS

FIG. 1 is a block diagram of an exemplary system for predicting failure of machine components;

FIG. 2 is a representation of exemplary data stored in a database of the system of FIG. 1;

FIG. 3 is a flowchart of an exemplary embodiment of a method of predicting failure of machine components;

FIG. 4 is an exemplary chart showing an exemplary set of repair data entered and stored within the database of the system of FIG. 1; and

FIG. 5 is an exemplary chart showing an exemplary set of recommendations based on the data stored within the database of the system of FIG. 1.

### DETAILED DESCRIPTION

Reference will now be made in detail to exemplary embodiments, which are illustrated in the accompanying drawings. Wherever possible, the same reference numbers will be used throughout the drawings to refer to the same or like parts.

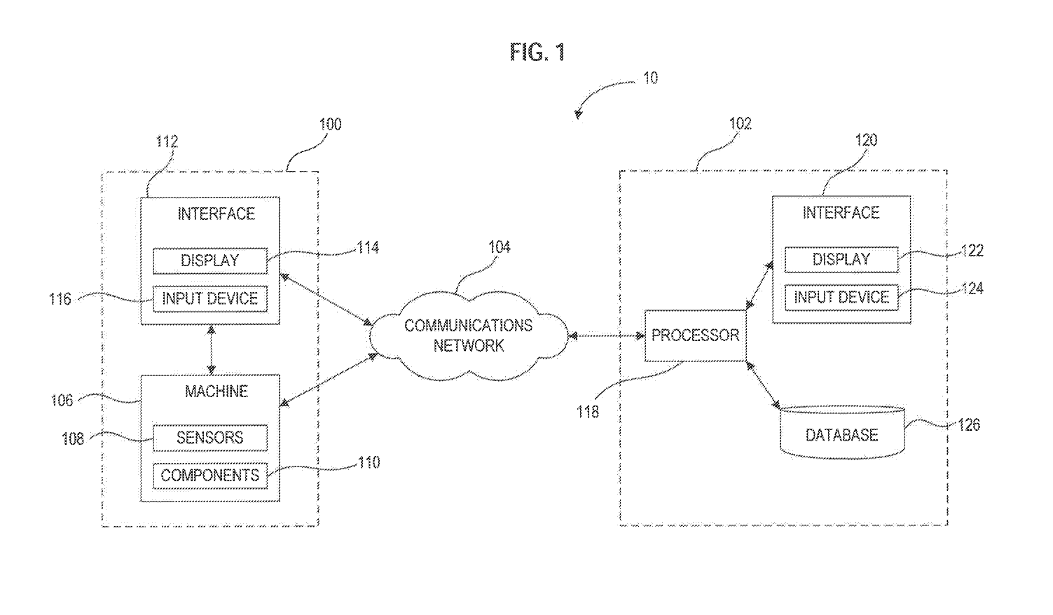

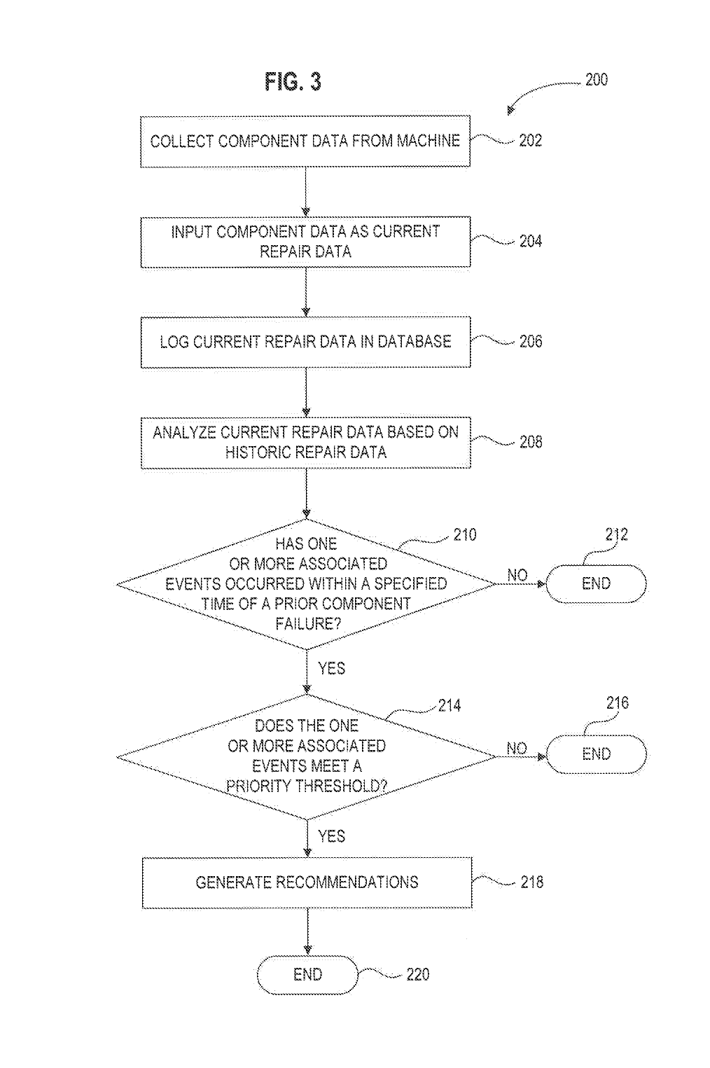

FIG. 1 depicts a block diagram of an exemplary system for predicting failure of machine components, where the system is generally designated 10. For purposes of this disclosure, the present system and method of predicting associated failures in machines, as shown in FIG. 3, are described in connection with remotely-located machines, including machines such as off-highway mining trucks, hydraulic excavators, track-type tractor, wheel loaders, and the like. However, the disclosed system and method are equally well-suited for use with various other equipment or machines. Furthermore, the present disclosure may refer to analysis of information collected from one part, sub-system, or system of one machine. However, the data may be collected and analyzed from a plurality of machines.

The system 10 shown in FIG. 1 includes an on-site system 100 and a remote system 102, which may be operably connected by a communications network 104. The on-site system 100 and its system elements may be located on-site of a machine currently being serviced, whereas the remote system 102 and its system elements may be located remotely, or off-site, of the machine currently being serviced. The system 10, and/or the on-site system 100, and/or the remote system 102, may be a server, client, mainframe, desktop, laptop, network computer, workstation, personal digital assistant (PDA), tablet PC, or the like. The communications network 104 may be, e.g., a telephone-based network (such as PBX or POTS), a local area network (LAN), a wide area network (WAN), the Internet or another packet-switched network, a dedicated intranet, a workstation peer-to-peer network, a direct link network, a wireless network, or another suitable network.

The on-site system 100 may include at least one machine 106. In FIG. 1, the on-site system 100 is depicted as including a single machine 106; however, the system and method of the present disclosure are equally applicable to on-site systems 100 having more than one machine 106. Furthermore, when more than one machine 106 is included with the on-site system 100, the machines may be the same machine, a fleet of related or similar machines, or, in some instances, a plurality of different machines. A plurality of machines 106 may be included from various work sites, for example, different mining sites.

As shown in FIG. 1, the machine 106 may include one or more sensors 108 and/or components 110. The components 110 can be a single part of the machine 106, or a system or a sub-system of the machine 106. A single-part component 110 may be, for example, a seal, tube, valve, bellows, or the like, whereas a sub-system or system may be a cooler or heat exchanger, an intake and/or exhaust manifold, a brake group, or the like. The sensors 108 may include one or more sensors 108 to sense data from one or more components 110 of the machine 106. The sensors 108 can be of a type known in the art for producing electrical signals in response to a level of operational parameters, and can sense data from the machine 106 and its components 110 including pulse-width modulated sensor data, frequency-based data, five volt analog sensor data, and switch data that has been effectively debounced. The sensors 108 may also be connected to an electronic module (not shown) of the machine 106.

The on-site system 100 of FIG. 1 also includes an interface 112, which may be operably connected to the communications network 104 and the machine 106, including the sensors 108 and components 110. The interface 112 can enable communication with the machine 106, and with the remote system 102 via the communications network 104. The interface 112 can include a display 114 and an input device 116. The display 114 may be an electronic display including, but not limited to, an LCD, CRT, plasma display, or the like, and may include a graphical user interface (GUI) (not shown). The input device 116 may be any known device, including but not limited to a keyboard, for inputting information. Although the input device 116 is shown as being an element separate from the display 114, in some embodiments the input device 116 may be formed as part of the display 114. Additionally, other types of interface devices, such as, for example, a hand held computing device, voice recognition device, touch screen, or the like, may be used to interface with the machine 106 and remote system 102.

The remote system 102 shown in FIG. 1 includes a processor 118, interface 120, and database 126. The processor 118, shown as being operably connected to the communications network 104, may communicate with the on-site system 100 and the database 126 to perform an analysis of current repair data, as described below with respect to FIG. 3. The processor 118 may include one or more known processing devices, such as a microprocessor from the Pentium™ or Xeon™ family manufactured by Intel™, the Turion™ family manufactured by AMD™, or any other type of processor.

The interface 120 may be operably connected to the processor 118. In some instances, the interface 120 may also be directly operably connected to the database 126 as opposed to being operably connected through the processor 118. The interface 120 can include a display 122 and an input device 124. The display 122 may be an LCD, CRT, plasma display, or the like, and may include a graphical user interface (GUI) (not shown). The input device 124 may be any known device, including but not limited to a keyboard, for inputting information. Although the input device 124 is shown as being an element separate from the display 122, in some embodiments the input device 124 may be formed as part of the display 122. Additionally, other types of interface devices, such as, for example, a hand held computing device, voice recognition device, touch screen, or the like, may be used to interface with the processor 118, the database 126, and the on-site system 100.

Data from one or more of the machines 106 can be gathered and stored in the database 126, to be used in the embodiments disclosed herein. Data can be gathered over the course of hours, days, weeks, months, or years, and stored and logged in the database 126.

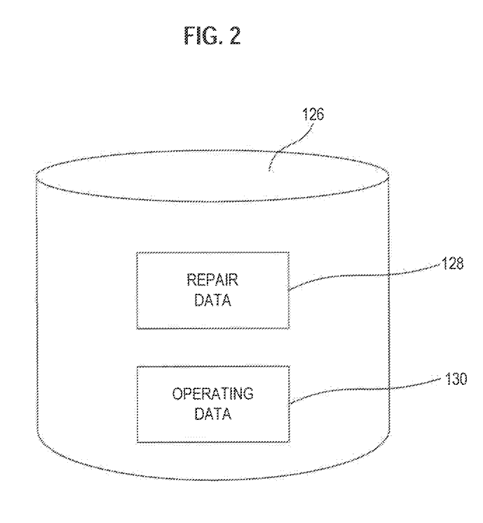

As shown in FIG. 2, the database 126 can be configured to store various types of data, including repair data 128 and operating data 130. “Repair data” can refer to “current repair data” from a current repair on a machine, and may include data such as the identity of the components, sub-systems, and/or systems of the machine. “Repair data” can also refer to data from a previous repair on a machine, and in that context may be referred to as “historic repair data,” which may include data such as the identity of the components, sub-systems, and/or systems of the machine. The identity of the first component, as well as the identity of the second component or associated components, may thus be stored in the database 126, along with the identities of other machine components, subs-systems, and/or systems. “Historic repair data” may refer to data collected over a period of time, for instance months or years, which can be stored in the database 126 for use by the disclosed system 10. “Repair data” may also be referred to herein as “work order data.” The historic repair data may be data collected from a single machine over a period of time, or from a number or fleet of the same or similar machines. For example, historic repair data could be collected over a period of months or years and stored in a single database 126 for a single haul truck, a fleet of haul trucks, or a number of haul trucks and similar, though not identical, mining trucks. While repair data may be described herein for a given machine, it may also refer to data collected for several of the same or similar machines, which may be useful for analyzing the performance of a fleet of machines.

“Operating data” and “historic operating data” can include, for example, engine RPM, oil pressure, water temperature, boost pressure, oil contamination, electric motor current, hydraulic pressure, system voltage, and the like. “Operating data” may also include data related to other conditions of the machine 106, including but not limited to payload, tire performance, and the like. The processor may analyze the current repair data of the current (first) component based on the historic operating data as part of generating the recommendation for servicing the associated (second) component. The data entered and stored within the database 126 can each include a time and/or date stamp. For example, data may be entered with a stamp of Jan. 1, 2000. The data stored within the database 126 may originate from, for example, a technician, machine manufacturer, dealers, and/or service providers. The repair data and/or the operating data can be collected and logged in the database 126 either manually or by one or more sensors 108.

In some embodiments, the database 126 may include one or more storage devices configured to store information or data, such as the repair data and operating data discussed above, which can be used by the processor 118 to perform certain functions related to the disclosed embodiments. Database 126 may include a volatile or non-volatile, magnetic, semiconductor, tape, optical, removable, nonremovable, or other type of storage device or computer-readable medium. Database 126, or another storage device (not shown) operably connected to the processor 118, may store programs and/or other information, such as information related to processing data. In one exemplary embodiment, the remote system 102 includes a memory (not shown) that may include one or more programs or subprograms loaded from the storage device or elsewhere that, when executed by the processor 118, perform various procedures, operations, or processes consistent with disclosed embodiments. For example, the memory may include one or more programs that enable the processor 118 to, among other things, analyze current repair data based on historic repair data, as discussed below in detail with respect to FIG. 3.

FIG. 3 is a flowchart of an exemplary embodiment of a method of predicting failure of machine components, to be performed by the system of FIG. 1, and in particular the processor 118. Generally, the system 10 is configured to identify recurring patterns in which different events, including component failures, have occurred historically within a specified time window and apply value prioritization, as discussed in more detail below. The system can be used to predict associated component failures that may occur based on statistically significant historical evidence triggered by the current repair data. Furthermore, the system includes the functionality to generate or output recommendations, also referred to as a checklist, to recommend preemptive repair and/or maintenance for one or more associated components predicted to fail.

An associated component refers to a component that often requires service (e.g., repair or replacement) around the time when a different component is being serviced. The component being serviced may be referred to as a “first component” or a “current component,” and the component that may require service may be referred to as a “second component,” “at least one second component,” or an “associated component.” In some instances, multiple components may require service around the time when another component (a first component or current component) is being serviced, in which case the multiple components requiring service may be referred to as “additional components” or “associated components.” The term “associated” does not require a component to be related to another component. In fact, as described in this disclosure, a component may be an associated component although it is not logically related to the other component being serviced.

Details of the method of predicting failure in machine components will now be discussed with reference to the flowchart in FIG. 3.

The method 200 shown in FIG. 3 includes step 202, where component data is collected from one or more machine 106, in accordance with FIG. 1 and its related description. The component data may be collected manually by a technician or other entity entering the component data using, for example, the input device 116 of the interface 112 shown in FIG. 1. Alternatively, the component data may be automatically collected and transmitted to the database 126 using the one or more of the machine sensors 108.

In step 204, the component data is input as current repair data. This may be accomplished either manually or automatically using the interface 112. The inputted current repair data may include, for example, identifying component information, such as the part number, for the component currently being serviced. In other instances, the interface 120 may be used to input the component data as current repair data. For example, an on-site technician could contact a remote technician with access to the remote system 102, and provide the remote technician with the component data to input as the current repair data.

In step 206, the current repair data is logged in the database 126. The current repair data can be logged by, for example, identifying component information, such as the part number of the component currently being serviced, and a date and/or time stamp indicating when the component was serviced.

A data cleaning step (not shown), which may also be referred to as a data cleansing or data scrubbing step, can be included as part of step 204 and/or step 206. Raw data may be inputted and logged as unclean data. A commonly employed data cleaning technique could be used to detect and correct inaccuracies in the data entered into the database. With respect to the current repair data inputted and logged into the database as described herein, a known data cleansing technique may be used to identify incomplete, incorrect, inaccurate, or irrelevant aspects of the repair data, and replace, modify, or delete the data so that it is consistent with other repair data stored in the database.

In steps 208, 210, and 214, an analysis of the current repair data is performed based on historic repair data stored in the database 126. The processor 118 of the remote system 102 may be configured to perform the analysis. Specifically, one or more algorithms, which may be accessible by or, in some instances, stored on the processor 118, can be applied to perform the analysis, as described in more detail below. The one or more algorithms may be used to extract data, such as repair data and/or operating data, from the database to determine when a machine component should be serviced or replaced, and recommend that the component be serviced or replaced.

In step 208, the current repair data, which was logged in step 206, is analyzed based on the historic repair data. To perform the analysis in step 208, a decision may be made according to step 210. Specifically, in step 210 the operating method depicted in FIG. 3 may determine whether one or more associated events occurred within a specified time of a prior component failure. As discussed herein, an associated event can be, for example, a failure of an associated component (a second component) other than the component currently being serviced (a first component). And the “prior component failure” can refer to a previous failure of the component currently being serviced (first component), where the data of the prior component failure is stored in the database 126.

To determine whether or more associated events occurred within a specified time of a prior component failure, an algorithm accessible by or stored on the processor 118 may be utilized. Specifically, the algorithm applied in step 210 may be a version of the Apriori algorithm, which is generally understood as being a generic type of algorithm useful for data mining and determining the frequency with which items in a dataset appear. Data mining may refer generally to the process of discerning patterns in data sets and extracting useful information from the discerned patterns. The terms “event,” “transaction,” or “item,” as used in this disclosure, may be used interchangeably to refer to a component, sub-system, or system failure, or a repair that occurs outside of normal operating conditions of a given machine.

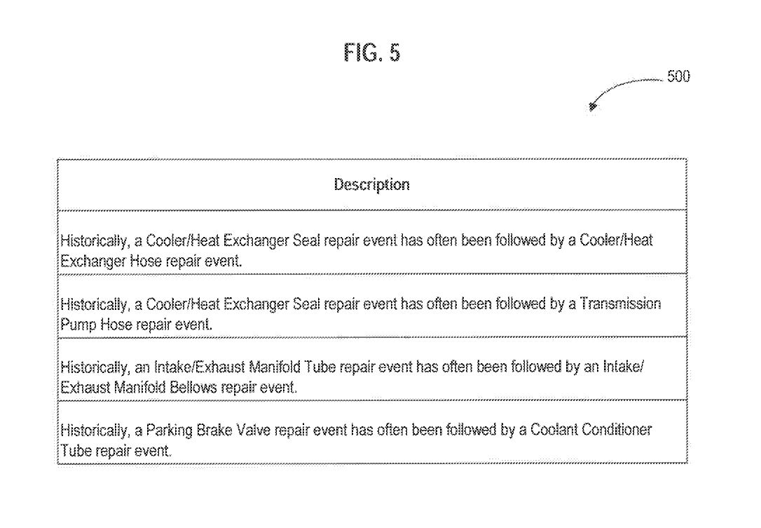

The present system and method may use a modified version of the Apriori algorithm to determine whether or not associated events occurred within a specified time of a prior component failure. Using the modified Apriori algorithm, each repair data logged in the database 126 as historic repair data may be logged as one time-stamped record. For example, one repair data entry or item may be “Change cooler/heat exchanger seal, Jan. 1, 2000.” The Apriori algorithm of the present disclosure can be applied through the processor 118 of the remote system 102 to detect whether one or more associated events occurred within a specified time of a prior component failure. For instance, the modified Apriori algorithm may include a time limitation (also referred to herein as a time period or a time window) of between 7 and 15 days. In that example, the analysis, using the modified Apriori algorithm, would exclude from possible recommendations (FIG. 3, step 218; FIG. 5) any associated events that occurred outside of a 7 to 15 day time period from a prior failure of the component currently being serviced. In another example, the Apriori algorithm may include a time limitation of 10 days, thereby excluding from possible recommendations any associated events that occurred more than 10 days from a prior failure of the component currently being serviced. The time limitation may be entered using the input device 124 of the interface 120. Alternatively, the time limitation may be entered using another input device of the remote system 102 or of a system separate from but operably connected to the remote system 102.

As yet another example, if the failure of a first component (e.g., cooler or heat-exchanger seal) occurs at a first time, the time for the failure of a second component (e.g., a cooler or heat exchanger hose, or a transmission pump hose) is measured as occurring at a second time after the first time. These time measurements are compiled in the database 126, which is accessible by the modified Apriori algorithm via the processor 118 of the remote system 102. It may then be determined that failure of the second component may be imminent within a time N (where N=second time−first time) after the failure of the first component.

The modified Apriori algorithm is thus an algorithm that can limit the possible recommendations by providing a time limitation, as discussed above. The modified Apriori algorithm described herein may be referred to as an Apriori-like algorithm, a modified Apriori algorithm, or simply an Apriori algorithm. This disclosure will specify if and when it refers to the generic Apriori algorithm rather than the above-described modified Apriori algorithm.

If it is determined that one or more associated events has not occurred within a specified time of a prior component failure, the process ends, as shown in step 212. However, if one or more associated events has occurred within a specified time of a prior component failure, it may then be determined whether the one or more associated events meets a priority threshold, as shown in step 214.

In step 214, to determine whether the one or more associated events meets a priority threshold, another algorithm accessible by or stored on the processor 118 may be utilized. Specifically, the algorithm applied in step 214 may be a Pareto algorithm. A Pareto algorithm is generally understood as being an algorithm that uses stored data to determine which events contribute to the majority, often 80%, of certain effects. The principle of the Pareto algorithm is often considered in business in that 80% of a company's sales may come from 20% of the company's customers or clients. In the context of this disclosure, the Pareto algorithm applied in step 214 can be used to determine which repair events tend to contribute to a certain percentage of the cost for machine downtime. The Pareto algorithm can also be applied to determine whether the one or more associated events is one of the repair events that tend to contribute to a high percentage of the cost, such that the one or more associated events will be included with the recommendations at step 218.

In one example, a threshold may be set in the present Pareto algorithm of about 80%. Applying this threshold, the analysis would determine what machine repairs have historically contributed to 80% or more of the total downtime repair cost. Those repairs that did not would not be included with recommendations generated in step 218.

For any single machine, there may be thousands (even tens or hundreds of thousands) of components, most or all of which can be grouped into sub-systems, which can be grouped into individual systems of the machine. The database 126 can store the cost of individual repair events, including the cost of the one or more associated events, along with the system, subsystem, and component(s) involved in each repair event. The identity of a system, subsystem, and/or component(s) involved in each repair event may constitute the historic repair data discussed in this disclosure. As an example, suppose that in one year there were 1,000 repair events for a given machine, and the 1,000 repair events resulted in $1,000,000 of total repair costs for that machine. And suppose that a total of 10,000 different components were involved in those 1,000 repair events. The 1,000 repair events involving 10,000 components and resulting in $1,000,000 of total repair costs may be referred to as the historic repair data. The disclosed Pareto algorithm, and specifically the priority threshold of the Pareto algorithm, can determine which of those 10,000 components were involved in the costliest repair events totaling at least $800,000, which is 80% of the total cost. The Pareto algorithm may thus be applied to compute the sum of repair events, starting with the most costly and continuing with the next most costly repair event, until the combined cost equals at least $800,000. In many instances, a small number of repair events, as compared to the total number of repair events, may account for a large amount of the total downtime repair cost for that machine. As a simple example, out of 1,000 repair events, 20 repair events may account for 80% of the total downtime repair cost. Although a time period of one year is discussed above, the time period on which the total repair cost for a given machine is based may be a period of days, weeks, months, or years. This time period may be set in the Pareto algorithm, for example, using the input device 124.

A threshold of 80% is only one example that is typical for Pareto algorithms. In other examples, the threshold could be set at a value higher than 80% (e.g., about 90% or about 95%) to provide for a more selective and exclusive analysis, or lower than 80% (e.g., about 70% or about 75%) to provide a more inclusive analysis. If, for example, there are a large number (e.g., twenty) of events that have occurred within a specified time of a prior component failure after the Apriori algorithm has run in step 210, the analysis in step 214 using the Pareto algorithm may further limit the number of events, depending on the threshold value as discussed herein. However, if there are a smaller number of events (e.g. five) after the Apriori algorithm has run, none of the events may be excluded from being generated as recommendations in step 218. A maximum number of events may be predetermined and set in the Pareto algorithm by, for example, using the input device 124. For instance, if the Pareto algorithm is applied after the Apriori algorithm, and the Pareto algorithm includes a maximum limit of five events, no more than five recommendations may be generated at step 218. When there is a maximum limit of events, the events may be the costliest events as discussed above. The maximum number of events allowed by the Pareto algorithm may be more or less than five, depending on factors including but not limited to the machine being serviced and the number of technicians available to provide service.

Due to machine complexity, there are numerous components that could potentially require service when another, seemingly unrelated component, is being serviced. While servicing a machine, expert technicians may try to apply domain knowledge expertise, which can be described as expert knowledge in the field, to predict whether a different component is on the verge of failure and should also be repaired or replaced. However, use of such domain knowledge expertise may result in too many potentially related components to service. The analysis, including application of the Pareto algorithm in step 214, can determine a priority of associated components to repair during any single instance of machine servicing. This process may also be referred as value prioritization.

Data of the cost of downtime represented, e.g., as a threshold percentage value, for various machine components, may be stored on database 126 to be input, manually or automatically, into the Pareto algorithm during the analysis of FIG. 3. This data may be entered using the input device 124 of the interface 120 or, alternatively, using another input device of the remote system 102 or of a system separate from but operably connected to the remote system 102. Additionally, data of the cost of downtime for various machine components may be stored on a separate database or storage means being part of the remote system 102 or part of a system separate from but operably connected to the remote system 102.

The analysis using the Apriori and Pareto algorithms described herein can thus be used to leverage data mining by discovering sequences of frequent itemsets. As used herein, the term “frequent itemsets” may refer to component failures that occur together. Whether a component failure is recognizable as a frequent itemset may depend on the timing input into the Apriori algorithm and the threshold for value prioritization input into the Pareto algorithm, as discussed above.

If the one or more associated events does not meet a priority threshold of the Pareto algorithm, the process ends, as shown in step 216. If, however, the one or more associated events meets a priority threshold of the Pareto algorithm, the process proceeds to step 218 and the processor 118 generates (outputs) recommendations of which associated components should be serviced, based on historic repair data stored within database 126. The recommendations may include one or more recommendations for servicing at least one associated component, which may be displayed on display 114. In some instances, the recommendations may be displayed on display 122. After generating recommendations at step 218, the method may end at step 220.

The system and method described herein may thus allow for a machine component, which is not currently being serviced, to be preemptively repaired based on a determination that the component may fail, where that determination is based on an identified association with failure of a component that is currently being serviced. For example, if the component currently undergoing repair is a heat exchanger seal, and historically a heat exchanger hose fails within seven days after replacing the heat exchanger seal, the disclosed system and method for predicting failure of machine components can provide an indication (recommendations) to a technician or other entity to inspect the hose when replacing the seal. If the hose is in need of repair or replacement, the heat exchanger seal and hose can be serviced at the same time.

Although the flowchart of FIG. 3 refers to “repair data,” the same method could be applied using “operating data,” as discussed above with reference to FIG. 2. For example, the method of FIG. 3 could be used with operating data 130, including but not limited to engine RPM, oil pressure, water temperature, boost pressure, oil contamination, electric motor current, hydraulic pressure, and system voltage. As described above, the operating data 130 may also be stored in the database 126. Additionally, although the algorithms are described as being stored in and accessible through the processor 118, in other embodiments either or both algorithms may be stored on other processing units and/or storage devices of either the on-site system 100 or the remote system 102. Also, in other embodiments steps 210 and 214 could be reversed, such that the Apriori algorithm is applied after the Pareto algorithm. That is, the method 200 could proceed such that it is first determined whether one or more associated events meets a priority threshold, and if so, it is then determined whether the one or more associated events has occurred within a specified time of a prior component failure. This method of operation could filter out small-cost repair events from the possible recommendations prior to filtering out additional associated repairs based on the time limitations of the Apriori algorithm. Thus, the Apriori and Pareto algorithms may not necessarily be dependent on one another.

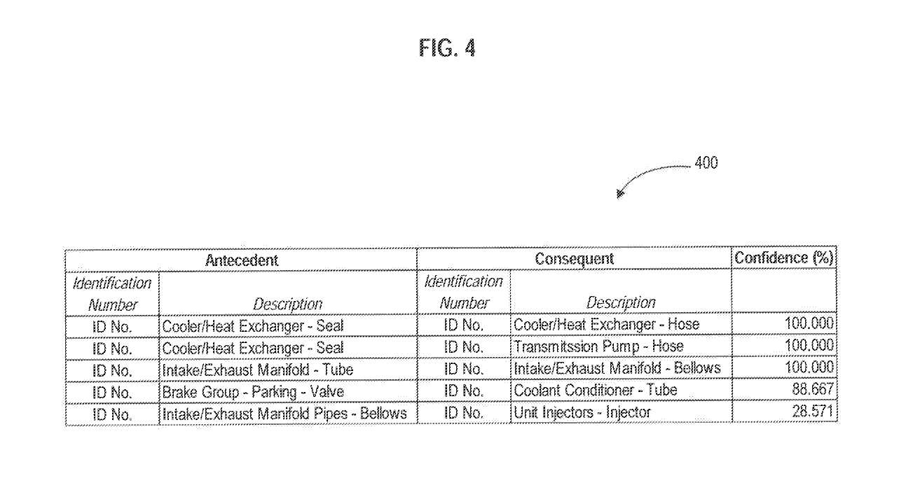

FIG. 4 depicts an exemplary chart 400 showing an exemplary set of repair data entered and stored within the database 126 of the system 10 of FIG. 1. “Antecedent” relates to repair data for a preceding event (e.g., failure) for a given (first) component. “Consequent” refers to repair data for an event (associated event) following the preceding event, which is determined to be associated with the preceding event in accordance with the system and method described herein. That is, the consequent can involve an associated (second) component that is different from the first component. The “Identification Number” columns may include numbers, such as part and/or model numbers, for a given component, subsystem, or system.

The “Confidence (%)” column indicates the confidence that the Antecedent and Consequent are related events. The confidence percentages can be statistically derived by applying the analysis of steps 208, 210, and/or 214, as described with respect to FIG. 3. For instance, the Apriori algorithm applied in step 210 of the present disclosure may be used to determine the confidence percentage. For a given antecedent event, the Apriori algorithm may use the data stored within database 126 to calculate the likelihood that the consequent will also occur within a time limit specified by the Apriori algorithm, where the likelihood can be expressed as a percentage. FIG. 4 shows, for example, that when a cooler/heat exchanger seal is serviced, 100.000% of the time the cooler/heat exchanger hose should also be serviced. Although FIG. 4 is referred to as depicting repair data, the chart could also depict “operating data” of the type shown and discussed with respect to FIG. 2.

FIG. 5 depicts an exemplary chart 500 showing an exemplary set of recommendations based on the data stored within the database of the system 10 of FIG. 1. The chart 500 of recommendations is a checklist showing which events are related and should be addressed by a technician. The chart 500 can include a Description column to describe the recommendation, which may include recommending a preemptive repair to an associated (i.e., a second) component. For example, if historically when repairing a cooler/heat exchanger seal, a repair of the cooler/heat exchanger hose has often followed, a recommendation may be generated with the following description: Historically, a Cooler/Heat Exchanger Seal repair event has often been followed by a Cooler/Heat Exchanger Hose repair event. This description provides notice to a technician to service the cooler/heat exchanger hose while servicing the cooler/heat exchanger seal. Additional possible descriptions are shown in FIG. 5, and various other descriptions could also be included depending on the component being serviced.

As shown in FIG. 5, a single chart, such as the chart 500, can include recommendations for various machine components. In some instances, a recommendation chart can be generated providing recommendations based on servicing a single machine component. In addition to the “Description” column shown in FIG. 5, the chart 500 may include, with regard to a specific machine component currently being serviced, additional columns specifying the component serial number, the date of the service, a model code, and/or the manufacturer. The chart 500 of recommendations may be accessible in the on-site system 100. For example, the display 114 may display the chart 500. Alternatively, another display not shown in FIG. 1 could be used to display the chart 500.

Those skilled in the art will appreciate that all or part of systems and methods consistent with the present disclosure may be stored on or read from other computer-readable media. Referring to FIG. 1, the system 10 may include a computer-readable medium having stored thereon computer-readable machine instructions which, when executed by the processor 118, may cause the processor 118 to perform, among other things, the methods disclosed herein, including the method of predicting failures in a machine. Exemplary computer readable media may include secondary storage devices, like hard disks, floppy disks, and CD-ROM; or other forms of computer-readable memory, such as read-only memory (ROM) or random-access memory (RAM). Such computer-readable media may be embodied by one or more components of the system 10, such as processor 118, database 126, interface 112, interface 120, machine 106, a server system, or combinations of these and other components.

### INDUSTRIAL APPLICABILITY

Although described for machines including trucks, hydraulic excavators, track-type tractors, and wheel loaders, the system and method of the present disclosure may be applicable in other industries that rely on machinery. For example, in addition to the automotive industry, the airline or shipping industries could apply the described system and method, as well as heavy equipment manufacturers seeking to provide data-leveraged services to customers seeking to minimize unscheduled machine downtime.

The disclosed system and method for predicting associated failure of machine components is a predictive tool triggered by repair data or operating data, which can be used to reliably preempt associated component failures. The system and method can leverage and mine a large amount of historical data, often spanning many months or years, in order to find patterns and relationships in the servicing of machine components. The system and method can also provide specific, actionable recommendations whenever a machine component is inspected, repaired, replaced, or otherwise serviced.

Additionally, by using the system and method disclosed herein, an inventory of repair and replacement parts can be maintained in a cost effective manner, as certain associated component failures can be predicted. For example, if the system determines that there is a correlation between an inlet exhaust manifold tube failure and an inlet exhaust manifold bellows failure, inventory can be kept for both scenarios so that they can be addressed at one time.

The disclosed system and method for predicting associated failure of machine components can thus minimize unscheduled and costly downtime for servicing machines and their components, sub-systems, and systems, by preempting associated component failures. The system and method described herein may be particularly useful in providing actionable intelligence, in the form of recommendations, for preempting associated failures of components in machines that are often too complex for expert technicians to accurately diagnose, especially when the associated components may not be logically connected within a given machine.

While the system and method described herein refers to predicting a component failure based on the repair of another component to determine failure patterns among machine components, it may also be used based on the repair of a sub-system or system of a machine to determine failure patterns among other machine sub-systems or systems, where the sub-systems and systems may include multiple components.

It will be apparent to those skilled in the art that various modifications and variations can be made to the disclosed system and method for predicting associated failure of machine components. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A system for predicting failure of one or more components of a machine, the system comprising:
at least one interface configured for inputting current repair data for a first component;
a database configured to log the current repair data of the first component; and
a processor operably connected to the at least one interface and the database, wherein the processor:
analyzes the current repair data of the first component based on historic repair data stored in the database, wherein the historic repair data includes the identity of a plurality of components of the machine, including the first component and a second component; and
generates a recommendation for servicing the second component based on the historic repair data stored in the database.

2. The system of claim 1, wherein to analyze the current repair data, the processor:
applies an Apriori algorithm having a time limitation to determine whether one or more associated events occurred within the time limitation; and
applies a Pareto algorithm having a priority threshold to determine whether the one or more associated events meets the priority threshold.

3. The system of claim 2, wherein:
the database stores the costs of individual repair events, including repair events included in the one or more associated events;
the priority threshold of the Pareto algorithm is a percentage of total repair costs for the machine over a period of time; and
the Pareto algorithm determines which machine components of the historic repair data were involved in repair events totaling the percentage of total repair costs of the priority threshold.

4. The system of claim 3, wherein the Pareto algorithm computes the sum of costs of the individual repair events, starting with the most costly and continuing with the next most costly repair event until the combined cost equals at least the priority threshold.

5. The system of claim 2, wherein the Pareto algorithm includes a maximum limit on the number of associated events that meet the priority threshold.

6. The system of claim 2, wherein the processor applies the Apriori algorithm after the Pareto algorithm.

7. The system of claim 2, wherein the Apriori algorithm is used to determine a confidence percentage indicating the likelihood that the one or more associated events will occur within the time limitation.

8. The system of claim 1, wherein:
the database has stored thereon historic operating data of the operating conditions of the machine, wherein the operating data includes at least one of engine RPM, oil pressure, water temperature, boost pressure, oil contamination, electric motor current, hydraulic pressure, system voltage, payload, and tire performance; and
the processor analyzes the current repair data of the first component based on the historic operating data as part of generating the recommendation for servicing the second component.

9. A method of predicting failure of components of a machine, the method comprising:
inputting current repair data for a first component of the machine into a database;
processing the repair data, wherein the processing includes:
analyzing the current repair data of the first component based on historic repair data stored in the database, wherein the historic repair data includes the identity of a plurality of components of the machine, including the first component and a second component; and
generating a recommendation for servicing the second component based on the historic repair data stored in the database; and
outputting a recommended repair checklist.

10. The method of claim 9, wherein the recommended repair checklist is displayed on an electronic display.

11. The method of claim 10, wherein the display is located on-site of the machine.

12. The method of claim 9, wherein the analyzing includes:
applying an Apriori algorithm having a time limitation to determine whether one or more associated events occurred within the time limitation; and
applying a Pareto algorithm having a priority threshold to determine whether the one or more associated events meets the priority threshold.

13. The method of claim 12, wherein the Apriori algorithm is used to determine a confidence percentage indicating the likelihood that the one or more associated events will occur within the time limitation.

14. The method of claim 12, wherein
the database stores the costs of individual of repair events, including repair events included in the one or more associated events;
the priority threshold of the Pareto algorithm is a percentage of total repair costs for the machine over a period of time; and
the Pareto algorithm determines which machine components of the historic repair data were involved in repair events totaling the percentage of total repair costs of the priority threshold.

15. The method of claim 14, wherein the Pareto algorithm computes the sum of costs of the individual repair events, starting with the most costly and continuing with the next most costly repair event until the combined cost equals at least the priority threshold.

16. The method of claim 12, wherein the Pareto algorithm includes a maximum limit on the number of associated events that meet the priority threshold.

17. A computer-readable medium having stored thereon computer-readable instructions which, when executed by a processor, cause the processor to perform a method of predicting failure of one or more components of a machine, the method comprising:
inputting current repair data for a first component of the machine into a database;
processing the repair data, wherein the processing includes:
analyzing the current repair data of the first component based on historic repair data stored in the database, wherein the historic repair data includes the identity of a plurality of components of the machine, including the first component and a second component; and
generating a recommendation for servicing the second component based on the historic repair data stored in the database; and
outputting a recommended repair checklist.

18. The computer-readable medium of claim 17, wherein the recommended repair checklist is displayed on an electronic display.

19. The computer-readable medium of claim 17, wherein the analyzing includes:
applying an Apriori algorithm having a time limitation to determine whether one or more associated events occurred within the time limitation; and
applying a Pareto algorithm having a priority threshold to determine whether the one or more associated events meets the priority threshold.

20. The computer-readable medium of claim 19, wherein the Apriori algorithm is used to determine a confidence percentage indicating the likelihood that the one or more associated events will occur within the time limitation.
